(19) United States
(12) Patent Application Publication
(10) Pub. No.: US 2024/0201529 A1
(43) Pub. Date: Jun. 20, 2024

(54) DISPLAY PANEL

(71) Applicant: Industrial Technology Research Institute, Hsinchu (TW)

(72) Inventors: Pao-Ju Hsieh, Hsinchu County (TW); Chyi-Ming Leu, Hsinchu County (TW); Tzong-Ming Lee, Hsinchu County (TW); Yu-Tsung Chiu, Taipei City (TW)

(73) Assignee: Industrial Technology Research Institute, Hsinchu (TW)

(21) Appl. No.: 18/192,628

(22) Filed: Mar. 29, 2023

(30) Foreign Application Priority Data
Dec. 16, 2022 (TW) 111148578

(51) Int. Cl. G02F 1/1333; G02F 1/1335

(52) U.S. Cl. CPC G02F 1/133305; G02F 1/133514; G02F 1/133528

(57) ABSTRACT

A display panel including a first substrate, a second substrate, and a display medium layer is provided. The second substrate is disposed opposite to the first substrate. The display medium layer is disposed between the first substrate and the second substrate. At least one of the first substrate and the second substrate includes a plastic base and a support layer, and the plastic base is disposed between the support layer and the display medium layer. A thickness of the support layer ranges from 0.3 mm to 3 mm.

### CROSS-REFERENCE TO RELATED APPLICATION

This application claims the priority benefit of Taiwanese application no. 111148578, filed on Dec. 16, 2022. The entirety of the above-mentioned patent application is hereby incorporated by reference herein and made a part of this specification.

### TECHNICAL FIELD

The disclosure relates to a display panel.

### BACKGROUND

Most of conventional liquid crystal display (LCD) panels adopt glass as a material of a substrate; however, a glass substrate has disadvantages of a relatively heavy weight, relatively high costs, and so on, and a significant amount of carbon dioxide (CO₂) may be emitted in a process of manufacturing the glass substrate, which results in a severe impact on the climate conditions on the earth.

Accordingly, a plastic material is proposed as the material of the substrate in the disclosure, so as to alleviate the aforesaid impact. Besides, when the display panel requires a curved surface, according to the related art, a thickness of the finished panel should be reduced in the conventional high-rigidity glass substrate, and such a process is cumbersome and risky. By contrast, the plastic substrate does not encounter such a problem. The plastic substrate is characterized by flexibility and may be easily processed, whereas a stiffness of the plastic substrate is relatively insufficient, which may affect the operability of the manufacturing process. For instance, when the plastic substrate is inadvertently bent to or below a certain curvature radius during operation, the resultant bending stress or deformation pushes liquid crystals toward the peripheries of the LCD panel, thus resulting in uneven distribution of the liquid crystals. At this time, the abnormality resulting from a liquid crystal cell gap may lead to mura defects in the display or other issues, which may affect the display quality of the LCD panel.

### SUMMARY

An embodiment of the disclosure provides a display panel that includes a first substrate, a second substrate, and a display medium layer. The second substrate is disposed opposite to the first substrate. The display medium layer is disposed between the first substrate and the second substrate. At least one of the first substrate and the second substrate includes a plastic base and a support layer, and the plastic base is disposed between the support layer and the display medium layer. A thickness of the support layer ranges from 0.3 mm to 3 mm.

Several exemplary embodiments accompanied with figures are described in detail below to further describe the disclosure in details.

### BRIEF DESCRIPTION OF THE DRAWINGS

The accompanying drawings are included to provide a further understanding of the disclosure, and the accompanying drawings are incorporated in and constitute a part of this specification. The drawings illustrate the embodiments of the disclosure, and together with the description, serve to explain the principle of the disclosure.

FIG. 1 is a schematic partial cross-sectional view of a display panel according to an embodiment of the disclosure.

FIG. 2A is a schematic partial cross-sectional view of a display panel according to a first embodiment of the disclosure.

FIG. 2B is a schematic partial cross-sectional view of a polarization layer according to an embodiment of the disclosure.

FIG. 2C is a schematic partial cross-sectional view of a polarization layer according to another embodiment of the disclosure.

FIG. 3 is a schematic partial cross-sectional view of a display panel according to a second embodiment of the disclosure.

FIG. 4 is a schematic partial cross-sectional view of a display panel according to a third embodiment of the disclosure.

FIG. 5 is a correlation curve diagram illustrating correlations between natural logarithms of a thickness of a support layer and a diagonal length of the display panel provided in the first embodiment of the disclosure when a curvature radius of the display panel is 300 mm, 400 mm, and 500 mm, respectively, where a material of the support layer is poly(methyl methacrylate) (PMMA).

FIG. 6 is a correlation curve diagram illustrating correlations between the natural logarithms of the thickness of the support layer and the diagonal length of the display panel provided in the first embodiment of the disclosure when the curvature radius of the display panel is 300 mm, 400 mm, and 500 mm, respectively, where a material of the support layer is polycarbonate (PC).

FIG. 7 is a correlation curve diagram illustrating correlations between the natural logarithms of the thickness of the support layer and the diagonal length of the display panel provided in the first embodiment of the disclosure when the curvature radius of the display panel is 300 mm, 400 mm, and 500 mm, respectively, where a material of the support layer is polyethylene naphthalate (PEN).

FIG. 8 is a correlation curve diagram illustrating correlations between the natural logarithms of the thickness of the support layer and the diagonal length of the display panel provided in the first embodiment of the disclosure when the curvature radius of the display panel is 300 mm, 400 mm, and 500 mm, respectively, where a material of the support layer is cyclo olefin polymer (COP).

### DETAILED DESCRIPTION OF DISCLOSURED EMBODIMENTS

The disclosure may be understood by referring to the following detailed description with reference to the accompanying drawings. It is noted that for comprehension of the reader and simplicity of the drawings, in the drawings provided in the disclosure, only a part of the electronic apparatus is shown, and certain devices in the drawings are not necessarily drawn to actual scale. Moreover, the quantity and the size of each device in the drawings are only schematic and exemplary and are not intended to limit the scope of protection provided in the disclosure.

In the following embodiments, wordings used to indicate directions, such as “up,” “down,” “front,” “back,” “left,” and “right,” merely refer to directions in the accompanying drawings. Therefore, the directional wordings are used to illustrate rather than limit the disclosure. In the accompanying drawings, the drawings illustrate the general features of the methods, structures, and/or materials used in the particular exemplary embodiments. However, the drawings shall not be interpreted as defining or limiting the scope or nature covered by the exemplary embodiments. For instance, the relative size, thickness, and location of film layers, regions, and/or structures may be reduced or enlarged for clarity.

When a corresponding component (such as a film layer or a region) is referred to as being “on another component”, the component may be directly on the other component or there may be another component between the two. On the other hand, when a component is referred to as being “directly on another component”, there is no component between the two. Also, when a component is referred to as being “on another component”, the two have a top-down relationship in the top view direction, and the component may be above or below the other component, and the top-down relationship depends on the orientation of the device.

The terminology “about,” “equal to,” “equivalent,” “same,” “substantially,” or “approximately,” is generally interpreted as being within 20% of a given value or range, or interpreted as being within 10%, 5%, 3%, 2%, 1%, or 0.5% of a given value or range.

The ordinal numbers used in the specification and claims, such as the terminologies “first”, “second” and the like, to qualify a component do not imply or represent that the component or components are preceded with any ordinal numbers, nor do they represent the order of a certain component and another component, or the order in the manufacturing method, and are used only so as to clearly distinguish a component with one name from another component with the same name. Different terminologies may be used in the claims and the specification, and accordingly, a first component in the specification may be a second component in the claims.

Note that in the following embodiments, the technical features provided in several different embodiments may be replaced, reorganized, and mixed without departing from the spirit of the disclosure so as to complete other embodiments. The technical features of the embodiments may be mixed and matched arbitrarily as long as they do not violate the spirit of the disclosure or conflict with each other.

Reference will now be made in detail to the exemplary embodiments of the disclosure, and examples of the exemplary embodiments are illustrated in the accompanying drawings. Whenever possible, the same reference numbers are used in the drawings and descriptions to indicate the same or similar parts.

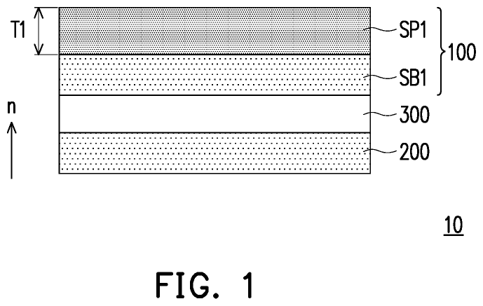

FIG. 1 is a schematic partial cross-sectional view of a display panel according to an embodiment of the disclosure.

With reference to FIG. 1, in some embodiments, a display panel 10 includes a first substrate 100, a second substrate 200, and a display medium layer 300. In the present embodiment, the display panel 10 is an LCD panel, which should however not be construed as a limitation in the disclosure. At least one of the first substrate 100 and the second substrate 200 may, for instance, include a plastic base and a support layer. In the embodiment shown in FIG. 1, the first substrate 100 includes a plastic base (a base SB1) and a support layer SP1, and the plastic base (the base SB1) is disposed between the support layer SP1 and the display medium layer 300, which should however not be construed as a limitation in the disclosure. In some embodiments, a thickness T1 of the support layer SP1 ranges from 0.3 mm to 3 mm.

Note that each structure included in the display panel 10 shown in FIG. 1 will be elaborated in the following embodiments.

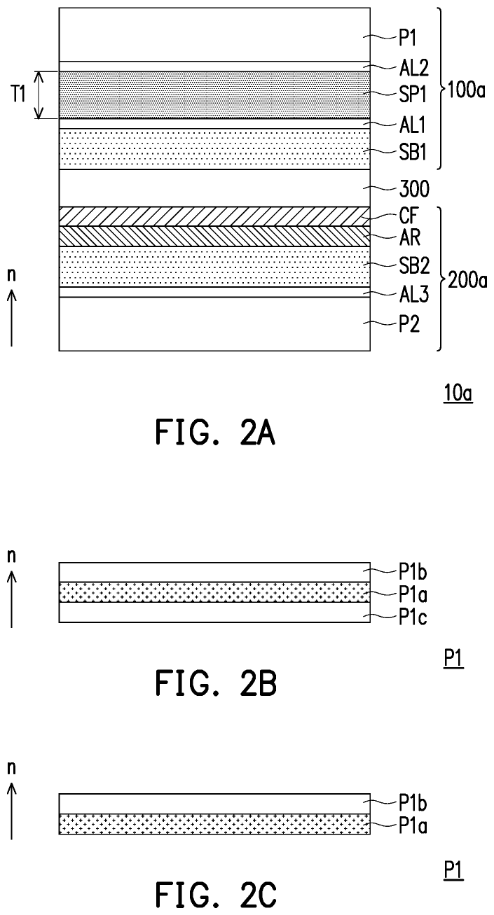

FIG. 2A is a schematic partial cross-sectional view of a display panel according to a first embodiment of the disclosure. FIG. 2B is a schematic partial cross-sectional view of a polarization layer according to an embodiment of the disclosure. FIG. 2C is a schematic partial cross-sectional view of a polarization layer according to another embodiment of the disclosure.

With reference to FIG. 2A, a display panel 10a provided in this embodiment includes a first substrate 100a, a second substrate 200a, and the display medium layer 300. In the present embodiment, the display panel 10a is an LCD panel, which should however not be construed as a limitation in the disclosure.

In some embodiments, at least one of the first substrate 100a and the second substrate 200a includes a plastic base and a support layer. When the first substrate and/or the second substrate includes the plastic base, the support layer may be configured to increase the stiffness of the first substrate and/or the stiffness of the second substrate, so that the display panel may have a relatively high curvature radius. The curvature radius of the display panel may be affected by the thickness of the support layer, a diagonal length of the display panel (the size of the display panel), and so on. For instance, the greater the thickness of the support layer, the greater the stiffness of the first substrate, so that the curvature radius of the display panel may increase; by contrast, the larger the diagonal length of the display panel, the lower the stiffness of the first substrate, so that the curvature radius of the display panel may decrease. Here, when the display panel has the curvature radius greater than or equal to 300 mm (R300), abnormal cell gaps and mura effects in the display panel may be reduced and mitigated. A linear correlation (as described in the following experimental examples) is found to exist between natural logarithms of the thickness of the support layer and the diagonal length of the display panel. In detail, the thickness of the support layer and the diagonal length of the display panel may conform to a formula of correlation represented by the following formula 1:

d_{R}=α ln(D)-β (formula 1),

where d_{R} is the thickness (in the unit of mm) of the support layer required for keeping the display panel to stay at least at a specific curvature radius R, D is the diagonal length (in the unit of inches) of the display panel; here, there is a positive linear constant function correlation between α and β and the curvature radius R of the display panel, and the larger the curvature of the display panel, the larger a and β. If the curvature radius R≥300, then α≥0.5, and β≥1.

In the above formula 1, in order to ensure the display panel to have the curvature radius greater than or equal to 300 mm, a is required to be ≥0.5 and β is required to ≥1, which will be elaborated in the following experimental examples.

The first substrate 100a serves as an upper substrate of the display panel 10a, for instance. In the present embodiment, the first substrate 100a includes the base SB1, the support layer SP1, and a polarization layer P1, which should however not be construed as a limitation in the disclosure. Specifically, the support layer SP1 is disposed between the base SB1 and the polarization layer P1 in a normal direction n of the display panel 10a.

A material of the base SB1 may include, for instance, plastic or glass. In the present embodiment, the material of the base SB1 may be plastic, which is, for instance, colorless polyimide (CPI), which should however not be construed as a limitation in the disclosure. In other embodiments, the base SB1 may include other transparent plastic materials. A thickness of the base SB1 is, for instance, less than 50 μm. In some embodiments, the base SB1 is the plastic base, and the thickness of the base SB1 is 20 μm-30 μm.

The support layer SP1 is, for instance, disposed on the base SB1. A material of the support layer SP1 may include transparent resin. For instance, the material of the support layer SP1 may include poly(methyl methacrylate) (PMMA), polycarbonate (PC), cyclo olefin polymer (COP), polyethylene terephthalate (PET), polyethylene naphthalate (PEN), or a combination thereof.

In the present embodiment, the support layer SP1 may be configured to increase the stiffness of the first substrate 100a, so that the display panel 10a may have a relatively high curvature radius, which will not be repeated hereinafter. In general, the thickness of the support layer SP1 and the diagonal length of the display panel 10a may conform to a formula of correlation represented by the following formula 1-1:

d_{R1}=α ln(D)-β (formula 1-1),

where d_{R1} is the thickness (in the unit of mm) of the support layer SP1, D is the diagonal length (in the unit of inches) of the display panel 10a, there is a positive linear constant function correlation between α and β and the curvature radius R of the display panel, and the larger the curvature of the display panel, the larger a and β.

In the above formula 1-1, in order to ensure the display panel 10a to have the curvature radius greater than or equal to 300 mm, a is required to be ≥0.5 and β is required to ≥1, which will be elaborated in the following experimental examples.

In the present embodiment, the thickness T1 of the support layer SP1 ranges from 0.3 mm to 3 mm. When the thickness T1 of the support layer SP1 is within the above range, abnormal cell gaps and mura effects in the display panel 10a may be reduced and mitigated, which will be elaborated in the following experimental examples.

In some embodiments, an adhesion layer AL1 is disposed between the support layer SP1 and the base SB1, where the adhesion layer AL1 is configured to adhere the support layer SP1 and the base SB1. A material of the adhesion layer AL1 may include transparent resin. For instance, the material of the adhesion layer AL1 may be an optical clear adhesive (OCA), which should however not be construed as a limitation in the disclosure.

The polarization layer P1 is, for instance, disposed on the support layer SP1. In some embodiments, the polarization layer P1 may have a sandwiched structure or a stacked layer structure. For instance, as shown in FIG. 2B, the polarization layer P1 may have a polarizer P1a as well as a protection layer P1b and a protection layer P1c disposed on opposite surfaces of the polarizer P1a, where the protection layer P1b is disposed on one surface of the polarizer P1a away from the support layer SP1, and the protection layer P1c is disposed on the other surface of the polarizer P1a close to the support layer SP1, which should however not be construed as a limitation in the disclosure. In some embodiments, as shown in FIG. 2C, the polarization layer P1 may only have the polarizer P1a and the protection layer P1b disposed on one surface of the polarizer P1a away from the support layer SP1, and the support layer SP1 may serve as another protection layer of the polarization layer P1, which should however not be construed as a limitation in the disclosure. The polarizer P1a is, for instance, a thin film with properties of light transmission and light deflection, and a material of the polarizer P1a may include, for instance, polyvinyl alcohol (PVA), which should however not be construed as a limitation in the disclosure. The protection layer P1b and the protection layer P1c are, for instance, configured to support and protect the polarizer P1a, so as to increase a mechanical strength of the polarization layer P1. Here, a material of the protection layer P1b may include, for instance, tri-acetyl cellulose (TAC), and a material of the protection layer P1c may include, for instance, TAC, PMMA (acrylic), or PET, which should however not be construed as a limitation in the disclosure.

In some embodiments, an adhesion layer AL2 is disposed between the polarization layer P1 and the support layer SP1, where the adhesion layer AL2 is configured to adhere the polarization layer P1 and the support layer SP1. A material of the adhesion layer AL2 may include transparent resin. For instance, the material of the adhesion layer AL2 may be a pressure sensitive adhesive (PSA), which should however not be construed as a limitation in the disclosure.

The second substrate 200a serves as a lower substrate of the display panel 10a, for instance. In the present embodiment, the second substrate 200a includes a polarization layer P2, a base SB2, a device layer AR, and a color filter layer CF, which should however not be construed as a limitation in the disclosure. In detail, as shown in FIG. 2A, the base SB2 is disposed between the polarization layer P2 and the display medium layer 300 (or the device layer AR) in the normal direction n of the display panel 10a, and the device layer AR is disposed between the base SB2 and the color filter layer CF in the normal direction n of the display panel 10a.

Note that the second substrate 200a provided in this embodiment is a color filter on array (COA) substrate which is a lower substrate where the color filter layer CF and the device layer AR are sequentially integrated on the base SB2; however, this should not be construed as a limitation in the disclosure. In some other embodiments, the device layer AR and the color filter layer CF in the second substrate 200a may be sequentially integrated on the base SB2, i.e., an array on color filter (AOC) substrate. Namely, the color filter layer CF is disposed between the base SB2 and the device layer AR.

A material of the base SB2 may include, for instance, plastic or glass. In the present embodiment, the material of the base SB2 may be plastic, which is, for instance, CPI, which should however not be construed as a limitation in the disclosure. In other embodiments, the base SB2 may include other transparent plastic materials. In some embodiments, note that the material of the base SB2 may be glass. A thickness of the base SB2 is, for instance, less than 30 μm. In some embodiments, the base SB2 is the plastic base, and the thickness of the base SB2 is 10 μm-20 μm.

The polarization layer P2 is, for instance, disposed on one surface of the base SB2 away from the first substrate 100a. The structure and the material of the polarization layer P2 may be the same as or similar to those of the polarization layer P1 of the first substrate 100a, for instance, and therefore no further description will be provided hereinafter.

In some embodiments, an adhesion layer AL3 is disposed between the polarization layer P2 and the base SB2, where the adhesion layer AL3 is configured to adhere the polarization layer P2 and the base SB2. A material of the adhesion layer AL3 may, for instance, be the same as or similar to the material of the adhesion layer AL2, and therefore no further description will be provided hereinafter.

The device layer AR is, for instance, disposed on the other surface of the base SB2 facing the first substrate 100a. The device layer AR may, for instance, include a plurality of signal lines (not shown), a plurality of transistors (not shown), and/or a plurality of electrodes (not shown), which should however not be construed as a limitation in the disclosure. The signal lines may, for instance, include a plurality of data lines (not shown), a plurality of scan lines (not shown), and/or other signal lines (such as a common voltage line, a power supply line, a working signal line, and so on) adapted to the display panel 10a. In some embodiments, a material of the device layer AR may include metal, nitride, metal oxide, or a combination thereof, for instance. The aforesaid metal may include Cu, Mo, Al, Ti, and other metals or their alloys that are adaptable to the display panel 10a, for instance. The aforesaid nitride may include TiNx, SiNx, and other nitrides adaptable to the display panel 10a, for instance. The aforesaid metal oxide may include indium tin oxide (ITO), indium zinc oxide (IZO), or other metal oxides adaptable to the display panel 10a, for instance, and the disclosure is not limited thereto.

The color filter layer CF is disposed on the device layer AR, for instance. The color filter layer CF may, for instance, include a plurality of color filter patterns (not shown), so that the display panel 10a may display colored images, which should however not be construed as a limitation in the disclosure. For instance, the color filter layer CF may include red color filter patterns, green color filter patterns, and/or blue color filter patterns, or filter patterns of other colors. In some embodiments, the corresponding filter patterns in the color filter layer CF may be partially overlapped with the corresponding transistors in the normal direction n of the display panel 10a, which should however not be construed as a limitation in the disclosure.

The display medium layer 300 is, for instance, disposed between the first substrate 100a and the second substrate 200a. In the present embodiment, the display media of the display medium layer 300 are liquid crystals, which should however not be construed as a limitation in the disclosure. The display media of the display medium layer 300 may be driven by transistors (not shown) and pixel electrodes (not shown) in the device layer AR and may then be arranged, for instance.

In some embodiments, a sealant (not shown) may be disposed between the first substrate 100a and the second substrate 200a. In detail, the sealant is disposed around the display medium layer 300, for instance. The sealant may be, for instance, configured to bond the first substrate 100a and the second substrate 200a. In some embodiments, the sealant and the first substrate 100a or the sealant and the second substrate 200a may form a space for accommodating the display medium layer 300, for instance.

In some embodiments, an alignment layer (not shown) may be disposed between the first substrate 100a and the second substrate 200a. In detail, the alignment layer (not shown) may be, for instance, disposed on a surface of the first substrate 100a facing the second substrate 200a and/or on a surface of the second substrate 200a facing the first substrate 100a. The alignment layer may, for instance, be configured to align the liquid crystals in a horizontal direction or a vertical direction and/or may, for instance, provide a liquid crystal pretilt angle. A material of the alignment layer may include, for instance, polyimide (P1), which should however not be construed as a limitation in the disclosure.

In some embodiments, a spacer (not shown) may be disposed between the first substrate 100a and the second substrate 200a. The spacer, for instance, is configured to support the first substrate 100a and/or the second substrate 200a, and may be configured to define a cell gap of the display panel 10a, for instance. The cell gap of the display panel 10a may be, for instance, a distance between two aforesaid alignment layers in the normal direction n of the display panel 10a, which should however not be construed as a limitation in the disclosure. A material of the spacer is not particularly limited in the disclosure and may include, for instance, an organic photosensitive material. In addition, the shape of the spacer is not particularly limited in the disclosure and may include, for instance, a columnar shape.

In some embodiments, the display panel 10a may be prepared by performing following steps, for instance, which should however not be construed as a limitation in the disclosure.

### (1) First, the First Substrate 100a and the Second Substrate 200a are Provided.

The first substrate 100a may be prepared, for instance, through performing the following steps, which should however not be construed as a limitation in the disclosure. For instance, first, a base material configured to form the base SB1, a base material of the support layer SP1, and a base material of the polarization layer P1 are sequentially bonded together in rolls and adhered together through the adhesion layer AL1 and the adhesion layer AL2, for instance. After that, the bonded base materials are cut to an appropriate size as required, so as to form the base SB1, the support layer SP1, and the polarization layer P1 that are stacked in sequence.

The second substrate 200a may be prepared, for instance, through performing the following steps, which should however not be construed as a limitation in the disclosure. For instance, the base SB2 is formed on a carrier (not shown), where a release layer (not shown) may be firstly formed between the base SB2 and the carrier, which should however not be construed as a limitation in the disclosure. After that, the device layer AR and the color filter layer CF are sequentially formed on a surface of the base SB2 away from the carrier.

### (2) Next, the Display Medium Layer 300 is Formed on the First Substrate 100a.

Before the display medium layer 300 is formed on the first substrate 100a, the sealant (not shown) may be disposed on the first substrate 100a. The display medium layer 300 may, for instance, fill the accommodation space defined by the sealant and the first substrate 100a, which should however not be construed as a limitation in the disclosure. In other embodiments, the display medium layer 300 may, for instance, fill the accommodation space defined by the sealant and the second substrate 200a; that is, the display medium layer 300 may be formed on the second substrate 200a.

### (3) Next, the First Substrate 100a and the Second Substrate 200a are Assembled.

The first substrate 100a and the second substrate 200a may be adhered to each other through the sealant, for instance. After the first substrate 100a and the second substrate 200a are assembled to each other, the carrier configured to carry the second substrate 200a may be removed by applying a mechanical lift-off method or a laser lift-off (LLO) method, for instance, which should not be construed as a limitation in the disclosure. After that, the polarization layer P2 is formed on the surface of the base SB2 away from the device layer AR.

So far, the manufacturing method of the display panel 10a is completed; however, the manufacturing method of the display panel 10a provided in one or more embodiments of the disclosure is not limited thereto.

In view of the above, according to this embodiment, through defining a is required to be ≥ 0.5 and β is required to be ≥1 in the linear correlation between the natural logarithms of the thickness of the support layer SP1 and the diagonal length of the display panel 10a, the support layer SP1 with the appropriate thickness may be selected according to the diagonal length of the display panel 10a, so that the curvature radius of the display panel 10a may be greater than or equal to 300 mm (R300), thereby reducing the abnormal cell gap and mitigating the mura effects in the display panel 10a.

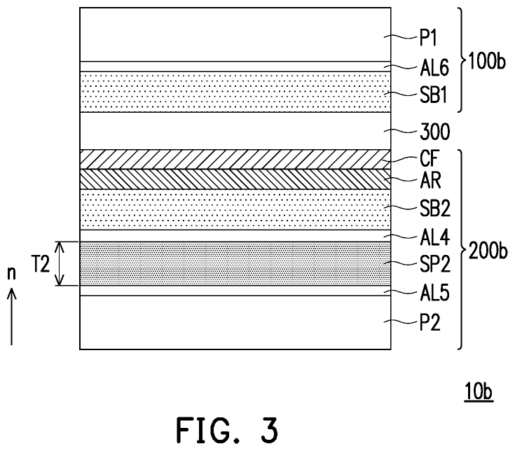

FIG. 3 is a schematic partial cross-sectional view of a display panel according to a second embodiment of the disclosure. It should be noted that the embodiment illustrated in FIG. 3 may use the reference numbers and some content provided in the embodiment illustrated in FIG. 2A, the same or similar reference numbers serve to represent the same or similar devices, and the description of the same technical content is omitted.

One of the differences between the display panel 10b shown in FIG. 3 and the display panel 10a provided above lies in that the display panel 10b includes a support layer SP2 but does not include the support layer SP1; that is, a second substrate 200b includes the support layer SP2, while a first substrate 100b does not includes the support layer SP1, where the polarization layer P1 in the first substrate 100b and the base SB1 are adhered to each other through an adhesion layer AL6.

In detail, the support layer SP2 is formed in the second substrate 200b of the display panel 10b and, for instance, disposed between the base SB2 and the polarization layer P2. A material of the support layer SP2 may, for instance, be the same as or similar to the material of the support layer SP1, and therefore no further description will be provided hereinafter.

The support layer SP2 may also be configured to increase the stiffness of the second substrate 200b, so that the display panel 10b may have a relatively high curvature radius. For instance, the curvature radius of the display panel 10b may be affected by the thickness of the support layer SP2, a diagonal length of the display panel 10b (the size of the display panel 10b), and so on, and therefore no further description will be provided hereinafter. In the present embodiment, the thickness of the support layer SP2 and the diagonal length of the display panel 10b may conform to a formula of correlation represented by the following formula 1-2:

d_{R2}-α ln(D)-β (formula 1-2),

where d_{R2} is the thickness (in the unit of mm) of the support layer SP2, D is the diagonal length (in the unit of inches) of the display panel 10b, there is a positive linear constant function correlation between α and β and the curvature radius R of the display panel 10b, and the larger the curvature of the display panel 10b, the larger a and β.

In the above formula 1-2, in order to ensure the display panel 10b to have the curvature radius greater than or equal to 300 mm, a is required to be ≥0.5 and ß is required to ≥1, which will be elaborated in the following experimental examples.

In the present embodiment, the thickness T2 of the support layer SP2 ranges from 0.3 mm to 3 mm. When the thickness T2 of the support layer SP2 is within the above range, abnormal cell gaps and mura effects in the display panel 10b may be reduced and mitigated, which will be elaborated in the following experimental examples.

In some embodiments, an adhesion layer AL4 is disposed between the support layer SP2 and the base SB2, where the adhesion layer AL4 is configured to adhere the support layer SP2 and the base SB2. A material of the adhesion layer AL4 may include transparent resin. For instance, the material of the adhesion layer AL4 may be an OCA, which should however not be construed as a limitation in the disclosure.

In some embodiments, an adhesion layer AL5 is disposed between the polarization layer P2 and the support layer SP2, where the adhesion layer AL5 is configured to adhere the polarization layer P2 and the support layer SP2. A material of the adhesion layer AL5 may include transparent resin. For instance, the material of the adhesion layer AL5 may be a PSA, which should however not be construed as a limitation in the disclosure.

In addition, at least one of the first substrate 100b and the second substrate 200b includes a plastic base and a support layer, for instance. For instance, in the present embodiment, the second substrate 200b of the display panel 10b includes the support layer SP2 and the base SB2 whose material may be CPI, which should however not be construed as a limitation in the disclosure.

In view of the above, according to this embodiment, through defining a is required to be ≥ 0.5 and β is required to be ≥1 in the linear correlation between the natural logarithms of the thickness of the support layer SP2 and the diagonal length of the display panel 10b, the support layer SP2 with the appropriate thickness may be selected according to the diagonal length of the display panel 10b, so that the curvature radius of the display panel 10b may be greater than or equal to 300 mm (R300), thereby reducing the abnormal cell gap and mitigating the mura effects in the display panel 10b.

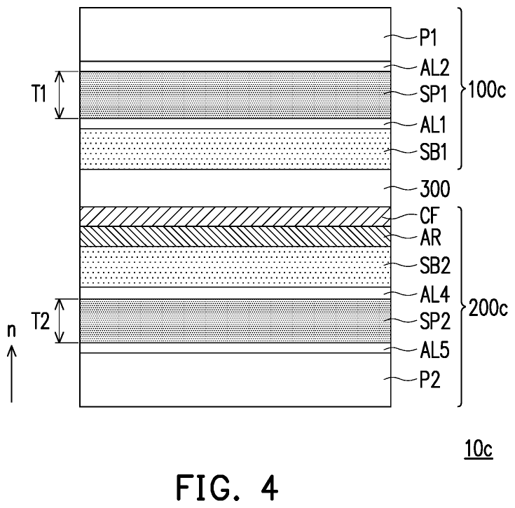

FIG. 4 is a schematic partial cross-sectional view of a display panel according to a third embodiment of the disclosure. It should be noted that the embodiment illustrated in FIG. 4 may use the reference numbers and some content provided in the embodiments illustrated in FIG. 2A and FIG. 3, the same or similar reference numbers serve to represent the same or similar devices, and the description of the same technical content is omitted.

One of the differences between the display panel 10c shown in FIG. 4 and the display panel 10a provided above lies in that the display panel 10c further includes the support layer SP2. Alternatively, one of the differences between the display panel 10c shown in FIG. 4 and the display panel 10a provided above lies in that the display panel 10c further includes the support layer SP1; that is, a first substrate 100c includes the support layer SP1, and a second substrate 200c includes the support layer SP2.

In the present embodiment, the support layer SP1 and the support layer SP2 may be configured to increase the stiffness of the first substrate 100c and the second substrate 200c, respectively, so that the display panel 10c may have a relatively high curvature radius. The curvature radius of the display panel 10c may be affected by the sum of the thickness of the support layer SP1 and the thickness of the support layer SP2, a diagonal length of the display panel 10c, and so on, and therefore no further description will be provided hereinafter. In the present embodiment, the sum of the thickness of the support layer SP1 and the thickness of the support layer SP2 and the diagonal length of the display panel 10c may conform to a formula of correlation represented by the following formula 1-3:

d_{RT}=α ln(D)-β (formula 1-3),

where d_{RT} is the sum (in the unit of mm) of the thickness of the support layer SP1 and the thickness of the support layer SP2, D is the diagonal length (in the unit of inches) of the display panel 10c, there is a positive linear constant function correlation between α and β and the curvature radius R of the display panel 10c, and the larger the curvature of the display panel 10c, the larger a and β.

In the above formula 1-3, in order to ensure the display panel 10c to have the curvature radius greater than or equal to 300 mm, a is required to be ≥0.5 and ß is required to ≥1, which will be elaborated in the following experimental examples.

In the present embodiment, the sum of the thickness T1 of the support layer SP1 and the thickness T2 of the support layer SP2 ranges from 0.3 mm to 3 mm. When the sum of the thickness T1 of the support layer SP1 and the thickness T2 of the support layer SP2 are within the above range, abnormal cell gaps and mura effects in the display panel 10c may be reduced and mitigated, which will be elaborated in the following experimental examples.

In view of the above, according to this embodiment, through defining a is required to be ≥0.5 and β is required to be ≥1 in the linear correlation between the natural logarithms of the sum of the thickness of the support layer SP1 and the thickness of the support layer SP2 and the diagonal length of the display panel 10c, the support layer SP1 and the support layer SP2 with the appropriate total thickness may be selected according to the diagonal length of the display panel 10c, so that the curvature radius of the display panel 10c may be greater than or equal to 300 mm (R300), thereby reducing the abnormal cell gap and mitigating the mura effects in the display panel 10c.

### Experimental Examples

Experimental examples are provided below for explanations, but these experimental examples are exemplary and are not intended to limit the scope of protection provided in the disclosure.

### Experimental Example 1

The display panel applied in the experimental example 1 has the structure of the display panel 10a shown in FIG. 2A and has the following configurations.

The first substrate 100a includes the base SB1, the adhesion layer AL1, the support layer SP1, the adhesion layer AL2, and the polarization layer P1.

The material of the base SB1 may be CPI, and the thickness of the base SB1 is 25 μm.

The material of the adhesion layer AL1 may be an OCA, and the thickness of adhesion layer AL1 is 25 μm.

The material of the support layer SP1 may be PMMA.

The material of the adhesion layer AL2 may be a PSA, and the thickness of the adhesion layer AL2 is 25 μm.

The polarization layer P1 has a sandwiched structure. In detail, the polarization layer P1 has the protection layer P1c, the polarizer P1a, and the protection layer P1b. The material of the polarizer P1a may be PVA, and the thickness of the polarizer P1a is 25 μm. The material of the protection layer P1b and the protection layer P1c may be TAC, and the thickness of each of the protection layer P1b and the protection layer P1c is 40 μm. That is, the thickness of the polarization layer P1 is 105 μm.

The second substrate 200a includes the polarization layer P2, the adhesion layer AL3, the base SB2, the device layer AR, and the color filter layer CF.

The polarization layer P2 has a sandwiched structure. In detail, the structure, the material, and the thickness of the polarization layer P2 are the same as those of the polarization layer P1, which will not be repeated hereinafter.

The material of the adhesion layer AL3 may be a PSA, and the thickness of the adhesion layer AL3 is 25 μm.

The material of the base SB2 may be CPI, and the thickness of the base SB2 is 12 μm.

The material of the display medium layer 300 may be liquid crystals, and the thickness of the display medium layer 300 is 40 μm.

The display panel 10a provided in this experimental example is constructed by applying the Ansys structure analysis software, where parameters input for the material (PMMA) the support layer SP1 is a modulus of 3 GPa and a density value 1.19.

In the experimental example 1, the support layers SP1 with different thicknesses and the display panel 10a with different diagonal lengths are selected to obtain data of the curvature radius of the display panel 10a corresponding to the support layer SP1 of the corresponding thickness in the display panel 10a having the corresponding diagonal length, which are summarized in Table 1 and Table 2 below. Compared to a structure which is not equipped with any support layer (the thickness of the support layer SP1=0 mm), the support layer SP1 provided in one or more embodiments of the disclosure may indeed improve the curvature radius of the display panel 10a, which may increase the operability of the manufacturing process, reduce the abnormal cell gap and mitigate the mura effects in the display panel, and improve the display quality.

TABLE 1

| Diagonal length | Thickness | Curvature radius |
|---|---|---|
| (inch) of the | (mm) of the | (mm) of the |
| display panel 10a | support layer SP1 | display panel 10a |
| 86 | 2.500 | 569.8 |
| | 2.000 | 463.7 |
| | 1.500 | 373.2 |
| | 1.200 | 322.8 |
| | 1.000 | 289.3 |
| 70 | 2.000 | 517.4 |
| | 1.500 | 392.1 |
| | 1.200 | 329.9 |
| | 1.000 | 291.9 |
| 50 | 1.500 | 505.5 |
| | 1.200 | 387.4 |
| | 1.000 | 323.3 |
| | 0.800 | 269.5 |
| | 0.000 | 90.7 |
| 32 | 1.000 | 543.8 |
| | 0.800 | 389.1 |
| | 0.700 | 329.5 |
| | 0.600 | 278.7 |
| 21 | 0.600 | 517.9 |
| | 0.500 | 402.4 |
| | 0.400 | 306.0 |
| | 0.350 | 265.2 |
| | 0.000 | 90.7 |

Next, with reference to the data in Table 1 above, the appropriate thickness of the support layer SP1 may be found according to the correlation between the diagonal length of the display panel 10a and the curvature radius of the display panel 10a. Here, when the material of the support layer SP1 is PMMA, a linear correlation is found to exist between natural logarithms of the thickness of the support layer SP1 and the diagonal length of the display panel 10a. That is, the thickness of the support layer SP1 and the diagonal length of the display panel 10a may conform to the formula of correlation represented by the formula 1 provided above.

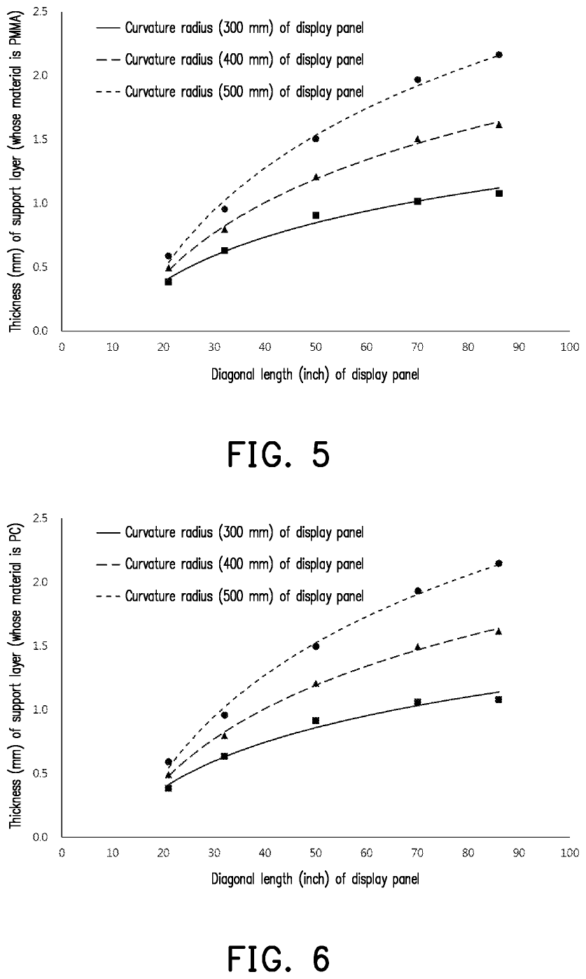

Specifically, in case that a curve fitting method is applied to set the desired curvature radius of the display panel 10a to be at least greater than R300, the required minimum thickness of the support later SP1 according to the diagonal length of the display panel 10a is obtained, as shown in FIG. 5, and the relevant data are summarized in Table 2 and Table 3 below.

TABLE 2

| Minimum thickness (mm) of the support | | Diagonal length (inch) of the display panel 10a | | | | |
|---|---|---|---|---|---|---|
| layer SP1 | | 86 | 70 | 50 | 32 | 21 |
| Curvature radius (mm) of the | 300 | 1.021 | 0.899 | 0.632 | 0.385 | 0.3855 |
| display panel 10a | 400 | 1.492 | 1.204 | 0.791 | 0.487 | 0.4877 |
| | 500 | 1.964 | 1.510 | 0.950 | 0.590 | 0.5900 |

TABLE 3

| | | Formula 1: d_{R1} = αln(D) − β | | |
|---|---|---|---|---|
| | | | | R square value |
| | | α | β | (accuracy) |
| Curvature radius (mm) of the | 300 | 0.5033 | 1.1211 | 0.986 |
| display panel 10a | 400 | 0.8261 | 2.0409 | 0.9975 |
| | 500 | 1.149 | 2.9607 | 0.9941 |

From Table 3, it may be learned that α and β are increased together with an increase in the curvature radius of the display panel; through further calculations of the correlations between α and β and the respective curvature radius (R) 300, 400, and 500 of the display panel 10a, it is found that a positive linear functional correlation exists between α and β and the curvature radius R of the display panel.

It may be learned from Table 2 that:
(1) When the diagonal length of the display panel 10a is 86 inches, the thickness of the support layer SP1 is required to be at least 1.084 mm to ensure the curvature radius of the display panel 10a to be greater than or equal to 300 mm;
(2) When the diagonal length of the display panel 10a is 70 inches, the thickness of the support layer SP1 is required to be around 1.021 mm to ensure the curvature radius of the display panel 10a to be greater than or equal to 300 mm;
(3) When the diagonal length of the display panel 10a is 50 inches, the thickness of the support layer SP1 is required to be 0.899 mm to ensure the curvature radius of the display panel 10a to be greater than or equal to 300 mm;
(4) When the diagonal length of the display panel 10a is 32 inches, the thickness of the support layer SP1 is required to be 0.632 mm to ensure the curvature radius of the display panel 10a to be greater than or equal to 300 mm; of the support layer SP1 is required to be 0.385 mm to ensure the curvature radius of the display panel 10a to be greater than or equal to 300 mm.

From Table 3, it may be learned that when the curvature radius of the display panel 10a is greater than or equal to 300 mm, the larger the curvature radius of the display panel 10a, the greater α and β in the formula 1, and when the curvature radius of the display panel 10a is 300 mm, a is 0.5033, and ß is 1.1211.

Accordingly, when the material of the support layer SP1 is PMMA, in order to ensure the display panel 10a to have the curvature radius greater than or equal to 300 mm, a in the formula 1 is required to be greater than or equal to 0.5033, and ß in the formula 1 is required to be greater than or equal to 1.1211.

### Experimental Example 2

In the experimental example 2, the structure and the configuration of the display panel 10a are similar to those provided in the experimental example 1, while the difference therebetween lies in that the material of the support layer SP1 is PC. Besides, parameters input for the material (PC) the support layer SP1 is a modulus of 3.24 GPa and a density value 1.26.

In the experimental example 2, the support layers SP1 with different thicknesses and the display panel 10a with different diagonal lengths are selected to obtain data of the curvature radius of the display panel 10a corresponding to the support layer SP1 of the corresponding thickness in the display panel 10a having the corresponding diagonal length, which are summarized in Table 4 below.

TABLE 4

| Diagonal length | Thickness | Curvature radius |
|---|---|---|
| (inch) of the | (mm) of the | (mm) of the |
| display panel 10a | support layer SP1 | display panel 10a |
| 86 | 2.500 | 571.9 |
| | 2.000 | 465.0 |
| | 1.500 | 374.1 |
| | 1.200 | 323.6 |
| | 1.000 | 289.9 |
| 70 | 2.000 | 519.4 |
| | 1.500 | 393.1 |
| | 1.200 | 330.8 |
| | 1.000 | 292.7 |
| 50 | 1.500 | 507.5 |
| | 1.200 | 387.4 |
| | 1.000 | 323.1 |
| | 0.800 | 269.1 |
| | 0.000 | 90.7 |
| 32 | 1.000 | 534.7 |
| | 0.800 | 389.0 |
| | 0.700 | 328.5 |
| | 0.600 | 277.8 |
| | 0.000 | 89.6 |
| 21 | 0.600 | 515.5 |
| | 0.500 | 400.4 |
| | 0.400 | 304.1 |
| | 0.300 | 228.8 |
| | 0.000 | 90.7 |

Next, with reference to the data in Table 4 above, the appropriate thickness of the support layer SP1 may be found according to the correlation between the diagonal length of the display panel 10a and the curvature radius of the display panel 10a. Here, when the material of the support layer SP1 is PC, a linear correlation is found to exist between natural logarithms of the thickness of the support layer SP1 and the diagonal length of the display panel 10a. That is, the thickness of the support layer SP1 and the diagonal length of the display panel 10a may conform to the formula of correlation represented by the formula 1 provided above.

Specifically, in case that a curve fitting method is applied to set the desired curvature radius of the display panel 10a to be at least greater than R300, the required minimum thickness of the support later SP1 according to the diagonal length of the display panel 10a is obtained, as shown in FIG. 6, and the relevant data are summarized in Table 5 and Table 6 below. Similarly, compared to a structure which is not equipped with any support layer (the thickness of the support layer SP1=0 mm), the support layer SP1 provided herein may indeed improve the curvature radius of the display panel 10a, which may increase the operability of the manufacturing process, reduce the abnormal cell gap and mitigate the mura effects in the display panel, and improve the display quality.

TABLE 5

| Minimum thickness (mm) of the support | | Diagonal length (inch) of the display panel 10a | | | | |
|---|---|---|---|---|---|---|
| layer SP1 | | 86 | 70 | 50 | 32 | 21 |
| Curvature radius (mm) of the | 300 | 1.080 | 1.058 | 0.917 | 0.634 | 0.386 |
| display panel 10a | 400 | 1.614 | 1.495 | 1.207 | 0.797 | 0.489 |
| | 500 | 2.147 | 1.932 | 1.497 | 0.961 | 0.593 |

TABLE 6

| | | Formula 1: d_{R1} = αln(D) − β | | |
|---|---|---|---|---|
| | | | | R square value |
| | | α | β | (accuracy) |
| Curvature radius (mm) of the | 300 | 0.514 | 1.1512 | 0.9773 |
| display panel 10a | 400 | 0.8216 | 2.0223 | 0.9973 |
| | 500 | 1.1292 | 2.8933 | 0.9955 |

From Table 6, it may be learned that a and β are increased together with an increase in the curvature radius of the display panel; through further calculations of the correlations between α and β and the respective curvature radius (R) 300, 400, and 500 of the display panel 10a, it is found that a positive linear functional correlation exists between α and β and the curvature radius R of the display panel.

It may be learned from Table 5 that:
(1) When the diagonal length of the display panel 10a is 86 inches, the thickness of the support layer SP1 is required to be at least 1.080 mm to ensure the curvature radius of the display panel 10a to be greater than or equal to 300 mm;
(2) When the diagonal length of the display panel 10a is 70 inches, the thickness of the support layer SP1 is required to be around 1.058 mm to ensure the curvature radius of the display panel 10a to be greater than or equal to 300 mm;
(3) When the diagonal length of the display panel 10a is 50 inches, the thickness of the support layer SP1 is required to be 0.917 mm to ensure the curvature radius of the display panel 10a to be greater than or equal to 300 mm;
(4) When the diagonal length of the display panel 10a is 32 inches, the thickness of the support layer SP1 is required to be 0.634 mm to ensure the curvature radius of the display panel 10a to be greater than or equal to 300 mm; of the support layer SP1 is required to be 0.386 mm to ensure the curvature radius of the display panel 10a to be greater than or equal to 300 mm.

From Table 6, it may be learned that when the curvature radius of the display panel 10a is greater than or equal to 300 mm, the larger the curvature radius of the display panel 10a, the greater α and β in the formula 1, and when the curvature radius of the display panel 10a is 300 mm, α is 0.514, and β is 1.1512.

Accordingly, when the material of the support layer SP1 is PC, in order to ensure the display panel 10a to have the curvature radius greater than or equal to 300 mm, a in the formula 1 is required to be greater than or equal to 0.514, and β in the formula 1 is required to be greater than or equal to 1.1512.

### Experimental Example 3

In the experimental example 3, the structure and the configuration of the display panel 10a are similar to those provided in the experimental example 1, while the difference therebetween lies in that the material of the support layer SP1 is PEN. Besides, parameters input for the material (PEN) the support layer SP1 is a modulus of 2.16 GPa and a density value 1.33.

In the experimental example 3, the support layers SP1 with different thicknesses and the display panel 10a with different diagonal lengths are selected to obtain data of the curvature radius of the display panel 10a corresponding to the support layer SP1 of the corresponding thickness in the display panel 10a having the corresponding diagonal length, which are summarized in Table 7 below. Compared to a structure which is not equipped with any support layer (the thickness of the support layer SP1=0 mm), the support layer SP1 provided herein may indeed improve the curvature radius of the display panel 10a, which may increase the operability of the manufacturing process, reduce the abnormal cell gap and mitigate the mura effects in the display panel, and improve the display quality.

TABLE 7

| Diagonal length | Thickness | Curvature radius |
|---|---|---|
| (inch) of the | (mm) of the | (mm) of the |
| display panel 10a | support layer SP1 | display panel 10a |
| 86 | 2.500 | 480.2 |
| | 2.000 | 404.0 |
| | 1.500 | 334.3 |
| | 1.200 | 293.2 |
| 70 | 2.500 | 541.7 |
| | 2.000 | 432.8 |
| | 1.500 | 343.6 |
| | 1.200 | 296.2 |
| 50 | 2.000 | 590.1 |
| | 1.500 | 410.7 |
| | 1.200 | 328.7 |
| | 1.000 | 282.9 |
| | 0.000 | 90.7 |
| 32 | 1.200 | 550.1 |
| | 1.000 | 425.2 |
| | 0.800 | 322.9 |
| | 0.700 | 280.0 |
| | 0.000 | 89.6 |
| 21 | 0.700 | 521.3 |
| | 0.600 | 422.7 |
| | 0.500 | 337.0 |
| | 0.400 | 263.3 |
| | 0.000 | 90.7 |

Next, with reference to the data in Table 7 above, the appropriate thickness of the support layer SP1 may be found according to the correlation between the diagonal length of the display panel 10a and the curvature radius of the display panel 10a. Here, when the material of the support layer SP1 is PEN, a linear correlation is found to exist between natural logarithms of the thickness of the support layer SP1 and the diagonal length of the display panel 10a. That is, the thickness of the support layer SP1 and the diagonal length of the display panel 10a may conform to the formula of correlation represented by the formula 1 provided above.

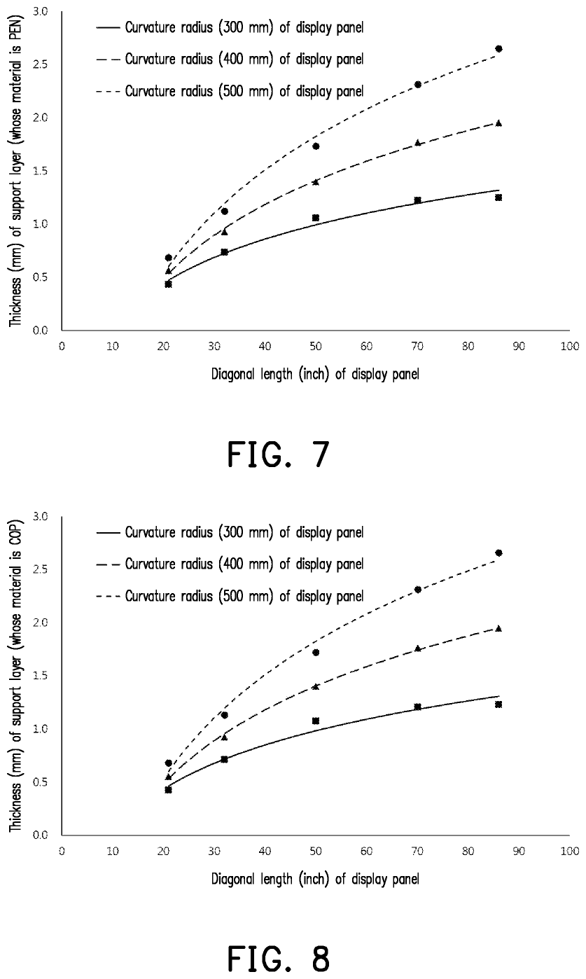

Specifically, in case that a curve fitting method is applied to set the desired curvature radius of the display panel 10a to be at least greater than R300, the required minimum thickness of the support later SP1 according to the diagonal length of the display panel 10a is obtained, as shown in FIG. 7, and the relevant data are summarized in Table 8 and Table 9 below.

TABLE 8

| Minimum thickness (mm) of the support | | Diagonal length (inch) of the display panel 10a | | | | |
|---|---|---|---|---|---|---|
| layer SP1 | | 86 | 70 | 50 | 32 | 21 |
| Curvature radius (mm) of the | 300 | 1.227 | 1.060 | 0.736 | 0.438 | 0.4388 |
| display panel 10a | 400 | 1.770 | 1.398 | 0.929 | 0.563 | 0.5633 |
| | 500 | 2.314 | 1.737 | 1.122 | 0.688 | 0.6888 |

TABLE 9

| | | Formula 1: d_{R1} = αln(D) − β | | |
|---|---|---|---|---|
| | | | | R square value |
| | | α | β | (accuracy) |
| Curvature radius (mm) of the | 300 | 0.6005 | 1.3544 | 0.9773 |
| display panel 10a | 400 | 1.0044 | 2.5193 | 0.9983 |
| | 500 | 1.4083 | 3.6842 | 0.9907 |

From Table 9, it may be learned that a and β are increased together with an increase in the curvature radius of the display panel; through further calculations of the correlations between a and β and the respective curvature radius (R) 300, 400, and 500 of the display panel 10a, it is found that a positive linear functional correlation exists between α and β and the curvature radius R of the display panel.

It may be learned from Table 8 that:
(1) When the diagonal length of the display panel 10a is 86 inches, the thickness of the support layer SP1 is required to be at least 1.253 mm to ensure the curvature radius of the display panel 10a to be greater than or equal to 300 mm;
(2) When the diagonal length of the display panel 10a is 70 inches, the thickness of the support layer SP1 is required to be around 1.227 mm to ensure the curvature radius of the display panel 10a to be greater than or equal to 300 mm;
(3) When the diagonal length of the display panel 10a is 50 inches, the thickness of the support layer SP1 is required to be 1.060 mm to ensure the curvature radius of the display panel 10a to be greater than or equal to 300 mm;
(4) When the diagonal length of the display panel 10a is 32 inches, the thickness of the support layer SP1 is required to be 0.736 mm to ensure the curvature radius of the display panel 10a to be greater than or equal to 300 mm; of the support layer SP1 is required to be 0.4386 mm to ensure the curvature radius of the display panel 10a to be greater than or equal to 300 mm.

From Table 9, it may be learned that when the curvature radius of the display panel 10a is greater than or equal to 300 mm, the larger the curvature radius of the display panel 10a, the greater α and β in the formula 1, and when the curvature radius of the display panel 10a is 300 mm, a is 0.6005, and β is 1.3544.

Accordingly, when the material of the support layer SP1 is PEN, in order to ensure the display panel 10a to have the curvature radius greater than or equal to 300 mm, a in the formula 1 is required to be greater than or equal to 0.6005, and β in the formula 1 is required to be greater than or equal to 1.3544.

### Experimental Example 4

In the experimental example 4, the structure and the configuration of the display panel 10a are similar to those provided in the experimental example 1, while the difference therebetween lies in that the material of the support layer SP1 is COP. Besides, parameters input for the material (COP) the support layer SP1 is a modulus of 1.32 GPa and a density value 0.9.

In the experimental example 4, the support layers SP1 with different thicknesses and the display panel 10a with different diagonal lengths are selected to obtain data of the curvature radius of the display panel 10a corresponding to the support layer SP1 of the corresponding thickness in the display panel 10a having the corresponding diagonal length, which are summarized in Table 10 below. Compared to a structure which is not equipped with any support layer (the thickness of the support layer SP1=0 mm), the support layer SP1 provided herein may indeed improve the curvature radius of the display panel 10a, which may increase the operability of the manufacturing process, reduce the abnormal cell gap and mitigate the mura effects in the display panel, and improve the display quality.

TABLE 10

| Diagonal length | Thickness | Curvature radius |
|---|---|---|
| (inch) of the | (mm) of the | (mm) of the |
| display panel 10a | support layer SP1 | display panel 10a |
| 86 | 2.500 | 479.2 |
| | 2.000 | 405.0 |
| | 1.500 | 336.7 |
| | 1.200 | 296.1 |
| 70 | 2.500 | 540.4 |
| | 2.000 | 434.1 |
| | 1.500 | 346.4 |
| | 1.200 | 299.5 |
| 50 | 2.000 | 592.8 |
| | 1.500 | 416.1 |
| | 1.200 | 334.1 |
| | 1.000 | 287.8 |
| | 0.000 | 90.7 |
| 32 | 1.000 | 438.2 |
| | 0.800 | 333.3 |
| | 0.700 | 288.8 |
| | 0.000 | 89.6 |
| 21 | 0.600 | 441.2 |
| | 0.500 | 350.8 |
| | 0.400 | 273.1 |
| | 0.000 | 90.7 |

Next, with reference to the data in Table 10 above, the appropriate thickness of the support layer SP1 may be found according to the correlation between the diagonal length of the display panel 10a and the curvature radius of the display panel 10a. Here, when the material of the support layer SP1 is COP, a linear correlation is found to exist between natural logarithms of the thickness of the support layer SP1 and the diagonal length of the display panel 10a. That is, the thickness of the support layer SP1 and the diagonal length of the display panel 10a may conform to the formula of correlation represented by the formula 1 provided above.

Specifically, in case that a curve fitting method is applied to set the desired curvature radius of the display panel 10a to be at least greater than R300, the required minimum thickness of the support later SP1 according to the diagonal length of the display panel 10a is obtained, as shown in FIG. 8, and the relevant data are summarized in Table 11 and Table 12 below. Compared to a structure which is not equipped with any support layer (the thickness of the support layer SP1=0 mm), the support layer SP1 provided herein may indeed improve the curvature radius of the display panel 10a, which may increase the operability of the manufacturing process, reduce the abnormal cell gap and mitigate the mura effects in the display panel, and improve the display quality.

TABLE 11

| Minimum thickness (mm) of the support | | Diagonal length (inch) of the display panel 10a | | | | |
|---|---|---|---|---|---|---|
| layer SP1 | | 86 | 70 | 50 | 32 | 21 |
| Curvature radius (mm) of the | 300 | 1.209 | 1.078 | 0.717 | 0.426 | 0.4266 |
| display panel 10a) | 400 | 1.762 | 1.400 | 0.927 | 0.555 | 0.5555 |
| | 500 | 2.315 | 1.723 | 1.136 | 0.683 | 0.6833 |

TABLE 12

| | | Formula 1: d_{R1} = αln(D) − β | | |
|---|---|---|---|---|
| | | | | R square value |
| | | α | β | (accuracy) |
| Curvature radius (mm) of the | 300 | 0.5986 | 1.357 | 0.9662 |
| display panel 10a | 400 | 1.0046 | 2.5244 | 0.9987 |
| | 500 | 1.4106 | 3.6919 | 0.9902 |

From Table 12, it may be learned that a and β are increased together with an increase in the curvature radius of the display panel; through further calculations of the correlations between α and β and the respective curvature radius (R) 300, 400, and 500 of the display panel 10a, it is found that a positive linear functional correlation exists between α and β and the curvature radius R of the display panel.

It may be learned from Table 11 that:
(1) When the diagonal length of the display panel 10a is 86 inches, the thickness of the support layer SP1 is required to be at least 1.233 mm to ensure the curvature radius of the display panel 10a to be greater than or equal to 300 mm;
(2) When the diagonal length of the display panel 10a is 70 inches, the thickness of the support layer SP1 is required to be around 1.209 mm to ensure the curvature radius of the display panel 10a to be greater than or equal to 300 mm;
(3) When the diagonal length of the display panel 10a is 50 inches, the thickness of the support layer SP1 is required to be 1.078 mm to ensure the curvature radius of the display panel 10a to be greater than or equal to 300 mm;
(4) When the diagonal length of the display panel 10a is 32 inches, the thickness of the support layer SP1 is required to be 0.717 mm to ensure the curvature radius of the display panel 10a to be greater than or equal to 300 mm; of the support layer SP1 is required to be 0.426 mm to ensure the curvature radius of the display panel 10a to be greater than or equal to 300 mm.

From Table 12, it may be learned that when the curvature radius of the display panel 10a is greater than or equal to 300 mm, the larger the curvature radius of the display panel 10a, the greater α and β in the formula 1, and when the curvature radius of the display panel 10a is 300 mm, α is 0.5986, and ß is 1.1357.

Accordingly, when the material of the support layer SP1 is COP, in order to ensure the display panel 10a to have the curvature radius greater than or equal to 300 mm, a in the formula 1 is required to be greater than or equal to 0.5986, and β in the formula 1 is required to be greater than or equal to 1.357.

Based on the above experimental example 1-experimental example 4, it may be known that there is a linear correlation between the thickness of the support layer SP1 and the natural logarithm of the diagonal length of the display panel, and in order to ensure the display panel to have the curvature radius greater than or equal to 300 mm, a in the formula 1 is required to be ≥0.5, and β is required to be ≥1. Accordingly, based on the data listed in the above experimental example 1-experimental example 4, it may be learned that the curvature radius of the display panel may be greater than or equal to 300 mm when the thickness of the support layer or the sum of the thicknesses of the support layers ranges from 0.3 mm and 3 mm.

To sum up, according to one or more embodiments of the disclosure, through defining a is required to be ≥0.5 and β is required to be ≥ 1 in the linear correlation between the natural logarithms of the thickness of the support layer and the diagonal length of the display panel, the support layer with the appropriate thickness (from 0.3 mm to 3 mm) may be selected according to the diagonal length of the display panel, so that the curvature radius of the display panel may be greater than or equal to 300 mm (R300), thereby reducing the abnormal cell gap and mitigating the mura effects in the display panel, and the resultant display panel may have good display quality.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

1. A display panel, comprising:
a first substrate;
a second substrate, disposed opposite to the first substrate; and
a display medium layer, disposed between the first substrate and the second substrate,
wherein at least one of the first substrate and the second substrate comprises a plastic base and a support layer, and the plastic base is disposed between the support layer and the display medium layer,
wherein a thickness of the support layer ranges from 0.3 mm to 3 mm,
wherein the thickness of the support layer and a diagonal length of the display panel conform to a following formula of correlation:
d_{R}1=α ln(D)-β,
wherein d_{R1} is the thickness of the support layer in a unit of mm, D is the diagonal length of the display panel in a unit of inches, α≥0.5, and β≥1.

2. The display panel according to claim 1, wherein the first substrate comprises a first base, a first support layer, and a first polarization layer, the first support layer is disposed between the first base and the first polarization layer in a normal direction of the display panel, the second substrate comprises a second base and a second polarization layer, and the second base is disposed between the second polarization layer and the display medium layer in the normal direction of the display panel, wherein the first base is the plastic base, and a material of the display medium layer comprises liquid crystal.

3. The display panel according to claim 2, wherein the second substrate further comprises a device layer and a color filter layer disposed on a surface of the second base away from the second polarization layer, wherein
the device layer is disposed between the color filter layer and the second base in the normal direction of the display panel; or
the color filter layer is disposed between the device layer and the second base in the normal direction of the display panel.

4. The display panel according to claim 1, wherein the first substrate comprises a first base and a first polarization layer, the first base is disposed between the first polarization layer and the display medium layer in a normal direction of the display panel, the second substrate comprises a second base, a second support layer, and a second polarization layer, and the second support layer is disposed between the second base and the second polarization layer in the normal direction of the display panel, wherein the second base is the plastic base, and the material of the display medium layer comprises liquid crystal.

5. The display panel according to claim 4, wherein the second substrate further comprises a device layer and a color filter layer disposed on a surface of the second base away from the second polarization layer, wherein
the device layer is disposed between the color filter layer and the second base in the normal direction of the display panel; or
the color filter layer is disposed between the device layer and the second base in the normal direction of the display panel.

6. The display panel according to claim 1, wherein the first substrate comprises a first base, a first support layer, and a first polarization layer, the first support layer is disposed between the first base and the first polarization layer in a normal direction of the display panel, the second substrate comprises a second base, a second support layer, and a second polarization layer, and the second support layer is disposed between the second base and the second polarization layer in the normal direction of the display panel, wherein the first base and the second base are the plastic base.

7. The display panel according to claim 6, wherein the second substrate further comprises a device layer and a color filter layer disposed on a surface of the second base away from the second polarization layer, wherein
the device layer is disposed between the color filter layer and the second base in the normal direction of the display panel; or
the color filter layer is disposed between the device layer and the second base in the normal direction of the display panel.

8. The display panel according to claim 1, wherein the first substrate comprises the plastic base, and a thickness of the plastic base ranges from 20 μm to 30 μm.

9. The display panel according to claim 1, wherein the material of the support layer comprises poly(methyl methacrylate), polycarbonate, cyclo olefin polymer, polyethylene terephthalate, polyethylene naphthalate, or a combination thereof.

10. The display panel according to claim 1, wherein the first substrate or the second substrate comprises a glass substrate.

11. The display panel according to claim 1, wherein the second substrate comprises the plastic base, and a thickness of the plastic base ranges from 10 μm to 20 μm.
